(19) United States
(12) Patent Application Publication
(10) Pub. No.: US 2018/0328764 A1
(43) Pub. Date: Nov. 15, 2018

(54) Method of Analyzing Signal Quality in Order to Determine the Operational Characteristics of a Measuring Device

(71) Applicants: Craig Alan D'Ambrosio, Chino, CA (US); Aaron James Thompson, Riverside, CA (US)

(72) Inventors: Craig Alan D'Ambrosio, Chino, CA (US); Aaron James Thompson, Riverside, CA (US)

(21) Appl. No.: 15/978,080

(22) Filed: May 11, 2018

Related U.S. Application Data
(60) Provisional application No. 62/504,883, filed on May 11, 2017.

(51) Int. Cl. G01D 9/28; G01D 9/00

(52) U.S. Cl. CPC G01D 9/28; G01D 9/005

(57) ABSTRACT

A method of analyzing signal quality in order to determine the operational characteristics of a measuring device uses a sampling device to monitor and analyze signal data that is generates by a measuring device or encoder. The sampling device is used to calculate and transmit data that characterizes the signals being generated by the measuring device. The method enables a user to interact with the sampling device, and this user interaction is mediated by a remote server. The method employs the sampling device to constantly monitor the signal data and then generate alerts whenever the measuring device is exhibiting characteristics that do not meet predefined thresholds. The sampling device periodically publishes the calculated characteristic data. Thus, enabling the user to understand the operational characteristics of the measuring device and predict when maintenance should be performed. The method enables the user to execute specific signal analysis processes when performing diagnostic tests.

The current application claims a priority to the U.S. Provisional Patent application Ser. No. 62/504,883 filed on May 11, 2017.

### FIELD OF THE INVENTION

The present invention relates generally to a method for analyzing signal data with a remote sensing device. More specifically, the present invention relates to a method of using a remote sensing device to facilitate preventative maintenance by analyzing the output of a measuring device.

### BACKGROUND OF THE INVENTION

Industrial measuring devices, such as linear scale or rotary encoders, are very delicate devices which need proper maintenance for high quality measurements. Minor contamination on the glass of measuring device will vastly reduce the quality of the signals provided by the measuring device. A user will not be aware the measuring device is not providing high quality signals until the measuring device reaches failure condition. The user of the measurement device will most likely seek a professional for maintenance on the measuring device to determine the quality problem of the measuring device. The professional can easily determine quality problems of the measuring device by analyzing the signals. The analysis of the signals of the measuring device allows the professional to provide the needed maintenance on the measuring device. However, the user must be physically present to analyze the signals of the measuring device and the quality problem may be more difficult to treat when if the measuring device is not serviced when the problem arises.

It is therefore an objective of the present invention to provide a remote detection device and method which includes a remote detection device which may be installed in-line with an industrial measuring device, such as a linear scale or rotary encoder, to analyze the signal quality continuously for predictive maintenance. The remote detection method includes a cloud-based monitoring system which communicates with the remote detection device when installed in-line with an industrial measuring device allowing a user to periodically monitor the signals of the measuring device. A maintenance professional will be able to periodically analyze the signals produce by a measuring device. The user of the measuring device may also monitor the signals of the measuring device. When the signals drop below a certain level, a maintenance professional will know to provide service to the measuring device before failure occurs.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is flowchart describing a sub-process for identifying the peaks in the signal that is analyzed using the method of the present invention.

FIG. 4 is flowchart describing a sub-process for checking the validity of the signal data using the method of the present invention.

FIG. 5 is flowchart describing various secondary sub-process that can be employed to further assess the validity of the signal data using the method of the present invention.

FIG. 6 is flowchart describing a sub-process for assessing the linearity of measured peaks within the signal data using the method of the present invention.

FIG. 7 is flowchart describing a sub-process for assessing the distribution of measured peaks within the signal data using the method of the present invention.

FIG. 8 is flowchart describing a sub-process for prefiltering the signal data in order to generate a standardized coordinate plane representation of the operational characteristics of the measuring device using the method of the present invention.

FIG. 9 is flowchart describing a continuation of the sub-process described in FIG. 8.

FIG. 10 is flowchart describing a sub-process for dividing relevant signal data into a plurality of zones using the method of the present invention.

FIG. 11 is flowchart describing a sub-process for generating a curve that represents an approximated version of relevant signal data using the method of the present invention.

FIG. 12 is flowchart describing a continuation of the sub-process described in FIG. 11.

FIG. 13 is flowchart describing a sub-process for calculating the phase shift between signals being analyzed using the method of the present invention.

FIG. 14 is flowchart describing a sub-process for extrapolating an upper switching threshold value, a lower switching threshold value, and a zero-crossing value using the method of the present invention.

### DETAIL DESCRIPTIONS OF THE INVENTION

All illustrations of the drawings are for the purpose of describing selected versions of the present invention and are not intended to limit the scope of the present invention.

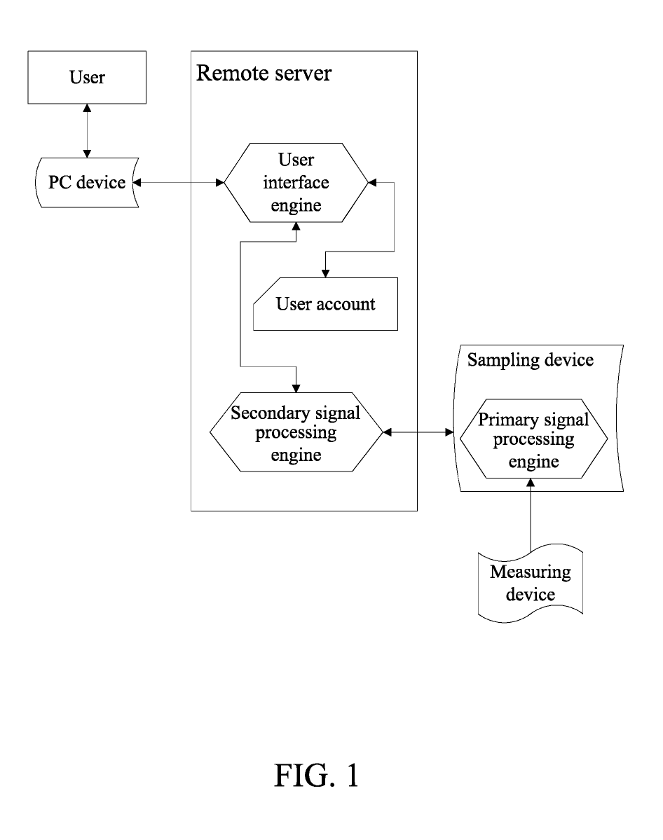

Referring to FIG. 1 through FIG. 14, the present invention is a method of analyzing signal quality in order to determine the operational characteristics of a measuring device. The method of the present invention employs the operational characteristics data to perform predictive analytics that enable a user to perform predictive maintenance on a measuring device., As a result, the user is able to identify when the measuring device is in need of repair. Additionally, the user is able to track any non-stationarity in any signals being produced by the measuring device over an extended period of time. The term “measuring device” is used herein to refer to electronic systems that convert variations in physical properties to electrical signals. Examples of measuring devices include, but are not limited to, encoders, sensors, and various transducers. The method of the present invention is designed to operate on a system that communicates the signal data from the sampling device to a remote server. Thus, making the signal data available to the user for remote analysis and triggered alerts. The term “signal data” is used herein to refer to data that contains digital representations of the signals generated by the measuring device, as well as any related analysis or characteristic data. Further, the method of the present invention is designed to employ a sampling device to perform preprocessing of the signal data, such that the sampling device is able to filter the signal data prior to generating alerts or messages. As a result, the method of the present invention is able to run as a background process that collects and analyzes the signal data generated by the measuring device. Additionally, the method of the present invention uses the sampling device to alert the user when the measuring device outputs signal data that conforms to predefined parameters. Further, the method of the present invention enables the user to direct the sampling device to perform signal analysis operations with the signal data.

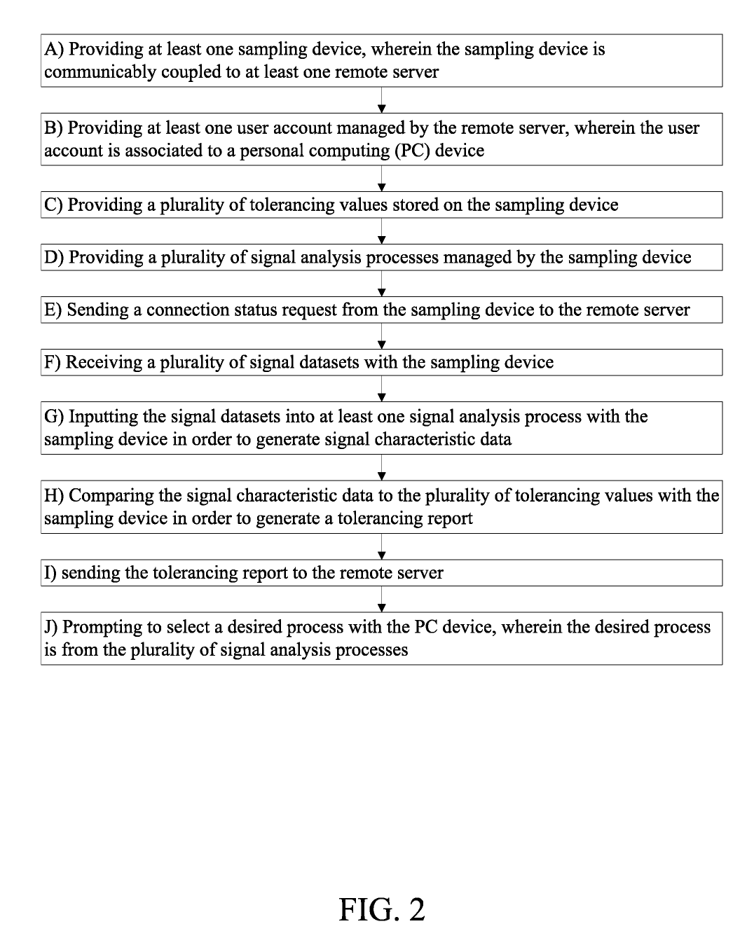

Referring to FIG. 1 and FIG. 2, the method of the present invention is executed on a system of distributed components that enable remote analysis of the signal data being generated by the measuring device. Specifically, the system for executing the method of the present invention provides at least one sampling device (Step A). Preferably the sampling device is a dedicated electrical system that can be communicably coupled to a signal output terminal of the measuring device. The sampling device is designed to analyze and record the signal data generated by the measuring device, without adding unwanted artifacts to the signal data. In an alternative embodiment, the sampling device is a system that is integrated into the measuring device. The sampling device is communicably coupled to at least one remote server so that signal data can be transmitted to a remote location and then shared with a plurality of external devices. The remote server is a computing system capable of storing signal data and executing a plurality of background processes while the method of the present invention is executed. Additionally, the remote server is designed to facilitate communication between the sampling device and a plurality of external systems. Specifically, the remote server facilitates communication between the sampling device and external systems by managing at least one user account (Step B). The user account is associated to a personal computing (PC) device so that the user is able to view data generated by the sampling device, transmit a plurality of commands to the sampling device, and receive alerts about the sampling device. Additionally, the term “PC device” can refer to electronic devices that include, but are not limited to, smartphones, laptops, and tablet computers. The system for executing the method makes use of a plurality of global variables and sub-processes that can be accessed when appropriate. Specifically, the system for executing the method of the present invention provides a plurality of tolerancing values stored on the sampling device (Step C). The plurality of tolerancing values comprises a set of predefined values against which the signal data is compared when executing various sub-processes. The system for executing the method of the present invention further provides a plurality of signal analysis processes managed by the sampling device (Step D). The plurality of signal analysis processes comprises a set of sub-processes that perform various transformations and analysis with the signal data. In the preferred embodiment of the present invention the sampling device is an electronic device capable of communicating with external systems, storing data, and executing a plurality of processes, such that the sampling device can operate without establishing a connection to the remote server. Once the sampling device is able to connect to the remote server, all stored data can be transmitted, and the sampling device will continue to operate as described. That is, the sampling device will periodically publish data. Further, the sampling device is capable of performing a plurality of setup routines, which define a set of system variables that are used when executing the method of the present invention. Preferably, the remote server is able to execute any of the plurality of signal analysis processes.

Referring to FIG. 1 and FIG. 2, the overall method of the present invention enables the sampling device to analyze, record, and transmit signal data. To that end, the overall method of the present invention begins by sending a connection status request from the sampling device to the remote server (Step E). The connection status message is a diagnostic transmission that tests the quality of the connection between the sampling device and the remote server. The sampling device then modifies the timing of data transmission and storage in accordance to the response to the connection status device. For example, if there is no response to the connection status request, the sampling device may store all signal data while periodically attempt to connect to and communicate with the remote server. The overall method of the present invention continues by receiving a plurality of signal datasets with the sampling device (Step F). The plurality of signal datasets comprises the signal data from the measuring device. As a result, the sampling device is able to receive and analyze the signal data in real time. The overall method of the present invention continues by inputting the signal datasets into at least one signal analysis process with the sampling device in order to generate signal characteristic data (Step G). The signal characteristic data is data that quantifies and describes the features of the signal data. The method of the present invention is designed to perform various transformations on the signal data in order to determine the operational characteristics of the measuring device. Further, the method of the present invention is designed to calculate preventative maintenance programs for the measuring device.

The method of the present invention is designed to perform validity checks that ensure the signal characteristic data falls within predefined thresholds and meets signal quality standards before transmitting alerts and publishing the results of any performed analysis. To accomplish this, the overall method of the present invention continues by comparing the signal characteristic data to the plurality of tolerancing values with the sampling device in order to generate a tolerancing report (Step H). The tolerancing report outlines the operational characteristics of the measuring device and identifies which characteristics fall outside of the tolerancing values. If the tolerancing report indicates that the measuring device is operating out of tolerance, then an alert is sent to the user through the PC device. That is, the overall method of the present invention continues by sending the tolerancing report to the PC device (Step I). As described above, the method of the present invention may be used to transmit alerts whenever the measuring device is not functioning properly. In addition to the aforementioned functionality, the method of the present invention is designed to publish tolerancing reports on a predefined schedule. As a result, the user is kept abreast of the operational state of the measuring device. Additionally, the remote server stores tolerancing reports to enable longitudinal data analysis. The overall method of the present invention continues by prompting to select a desired process with the PC device (Step J). The desired process is a signal analysis process that the user would like to execute to analyze the signal data, Thus, the user is able to perform additional diagnostic analysis of the signal data if an alert is received. Additionally, the user is able to perform periodic system operation checks for compliance with maintenance standards.

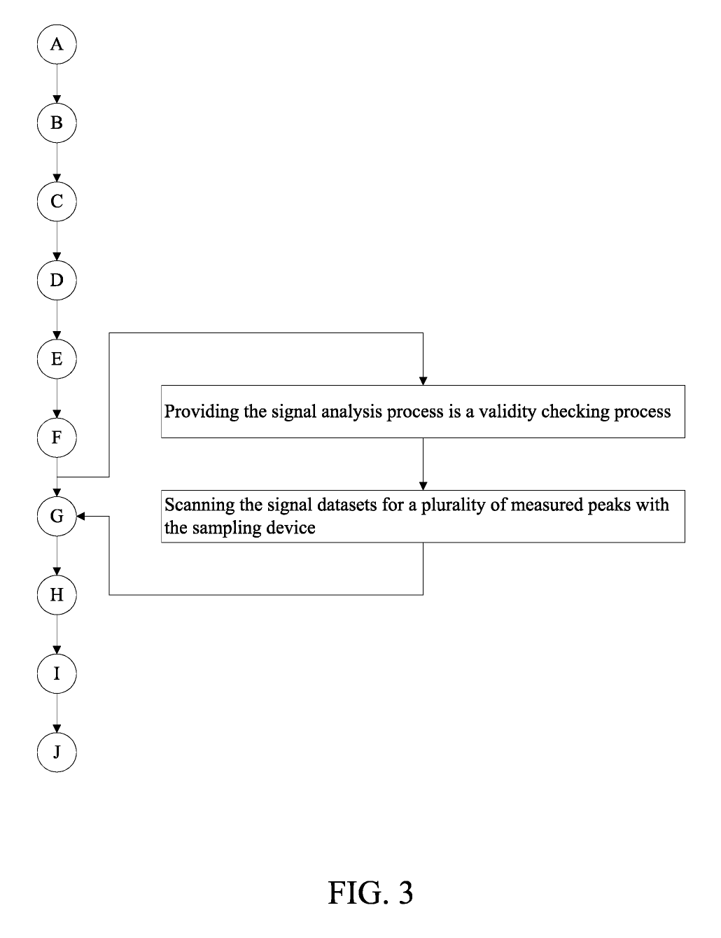

Referring to FIG. 3, as described above, the method of the present invention employs the plurality of signal analysis processes to identify the operational characteristics of the measuring device. Accordingly, a peak measuring process is used to identify peaks in the signal data. That is, the peak measuring process scans the signal datasets to identify a plurality of measured peaks with the sampling device. The plurality of measured peaks comprises a set of datapoints that describe the peak values within the signal data being analyzed.

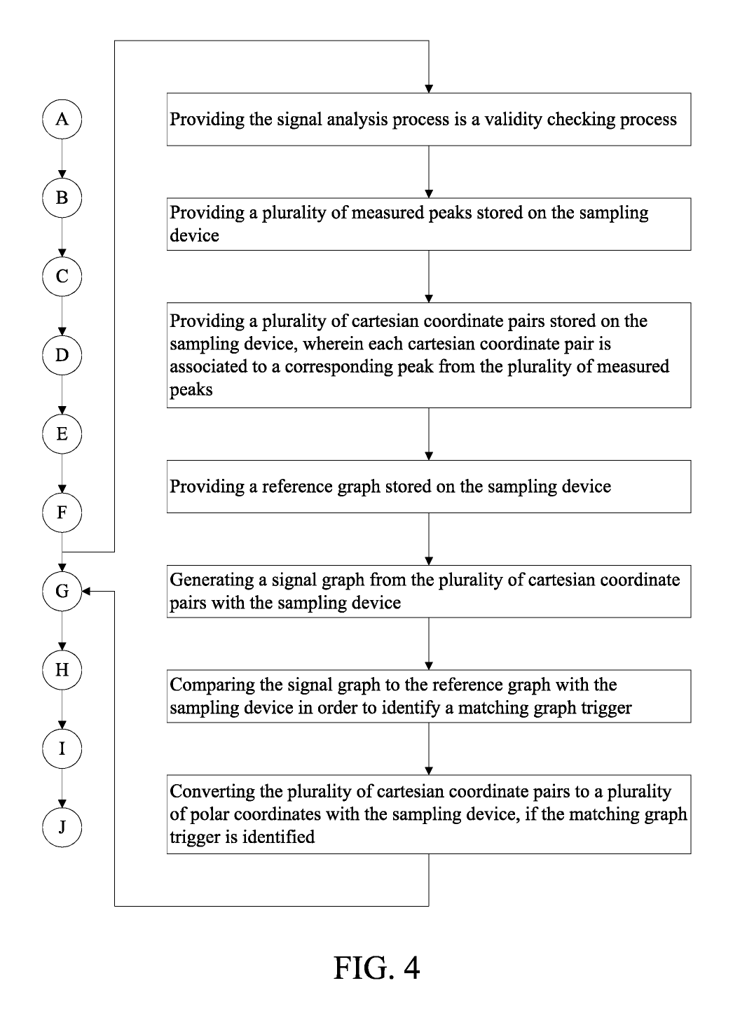

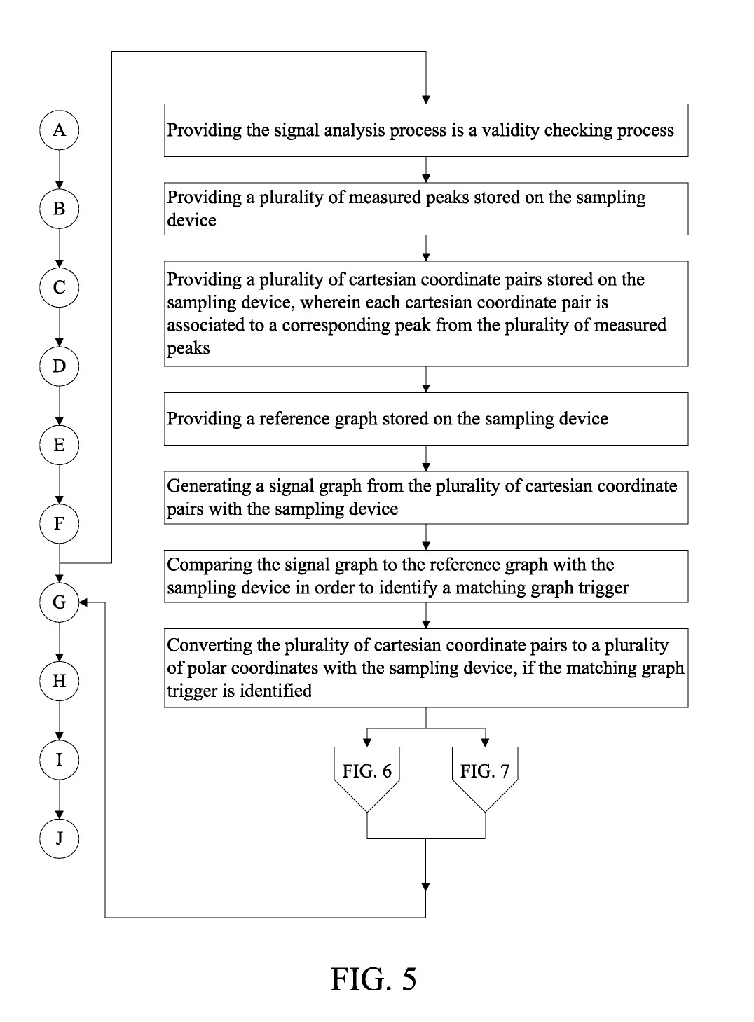

Referring to FIG. 4 and FIG. 5, the method of the present invention is designed to determine if the data being reported by the sampling device is accurate. To that end, the plurality of signal analysis processes includes a validity checking process that is executed to perform secondary analysis of any analyzed signal data. While analyzing the signal data the peak measuring process provides a plurality of cartesian coordinate pairs stored on the sampling device. Specifically, each cartesian coordinate pair is associated to a corresponding peak from the plurality of measured peaks. As a result, the signal data can be converted between various coordinate systems. The system for executing the method of the present invention provides a reference graph stored on the sampling device. The reference graph is a predefined curve against which the signal data will be compared. Preferably, the reference graph is in the shape of a Lissajous. The validity checking process begins by generating a signal graph from the plurality of cartesian coordinate pairs with the sampling device. The signal graph is a curve that plots the plurality of measured peaks. The validity checking process continues by comparing the signal graph to the reference graph with the sampling device in order to identify a matching graph trigger. The matching graph trigger is a flag that denotes the signal graph as conforming to the shape of the reference graph. The validity checking process continues by converting the plurality of cartesian coordinate pairs to a plurality of polar coordinates with the sampling device, if the matching graph trigger is identified. Thus, the validity checking process prepares the signal data to be inputted into a plurality of sub-processes that are used to further assess the accuracy of the signal data.

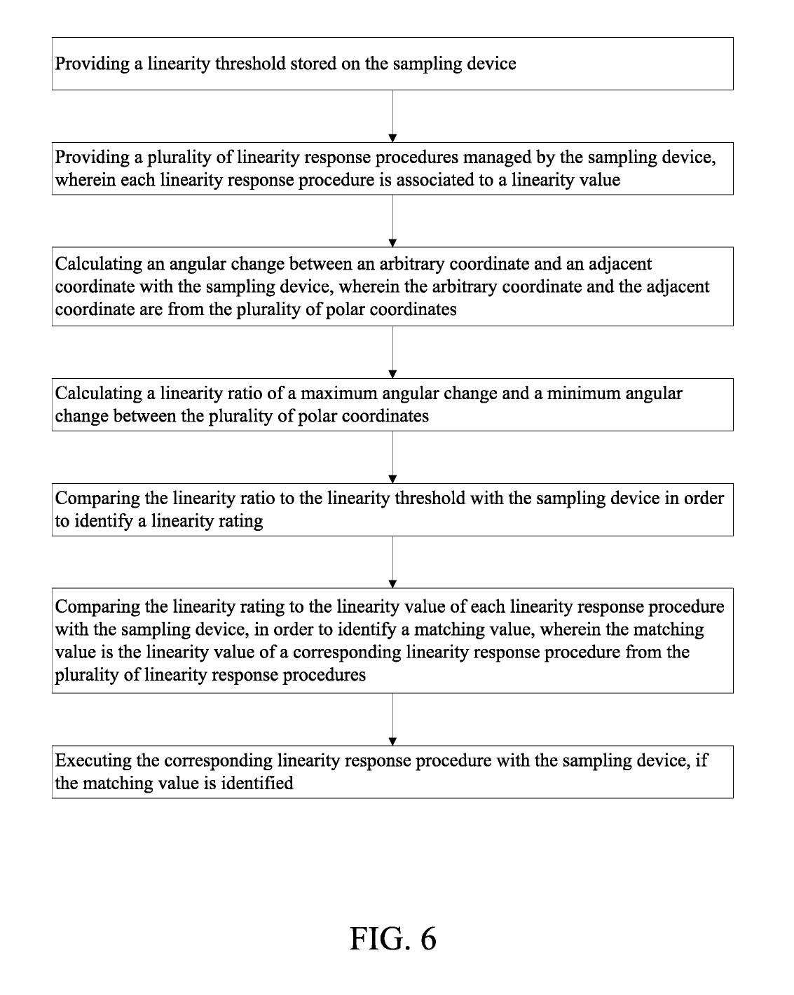

Referring to FIG. 5 and FIG. 6, a first sub-process of the validity checking process is used to assess the linearity of the signal data. To facilitate this sub-process, the system for executing the method of the present invention provides a linearity threshold stored on the sampling device. The linearity threshold is a predefined value that denotes a cutoff point for signal data that is considered valid. The system for executing the method of the present invention further provides a plurality of linearity response procedures managed by the sampling device. The plurality of linearity response procedures comprises a set of routines that denote the proper steps to take after the linearity of the signal data is analyzed. Additionally, each linearity response procedure is associated to a linearity value. The linearity value denotes a score that will be assigned to the signal data after the linearity is analyzed. The sub-process begins by calculating an angular change between an arbitrary coordinate and an adjacent coordinate with the sampling device. Additionally, the arbitrary coordinate and the adjacent coordinate are from the plurality of polar coordinates. The sub-process first finds the angular change between each of the polar coordinates that represent the signal data. The sub-process continues by calculating a linearity ratio of a maximum angular change and a minimum angular change between the plurality of polar coordinates. Thus, quantifying the Non-linearity of the plurality of polar coordinates. The sub-process continues by comparing the linearity ratio to the linearity threshold with the sampling device in order to identify a linearity rating. The linearity rating identifies the signal data as valid or invalid and assigns a value to the denote the linearity of the signal data. The sub-process continues by comparing the linearity rating to the linearity value of each linearity response procedure with the sampling device, in order to identify a matching value. The matching value is the linearity value of a corresponding linearity response procedure from the plurality of linearity response procedures. Accordingly, the sub-process is able to identify the appropriate linearity response procedure to execute. The sub-process concludes by executing the corresponding linearity response procedure with the sampling device, if the matching value is identified.

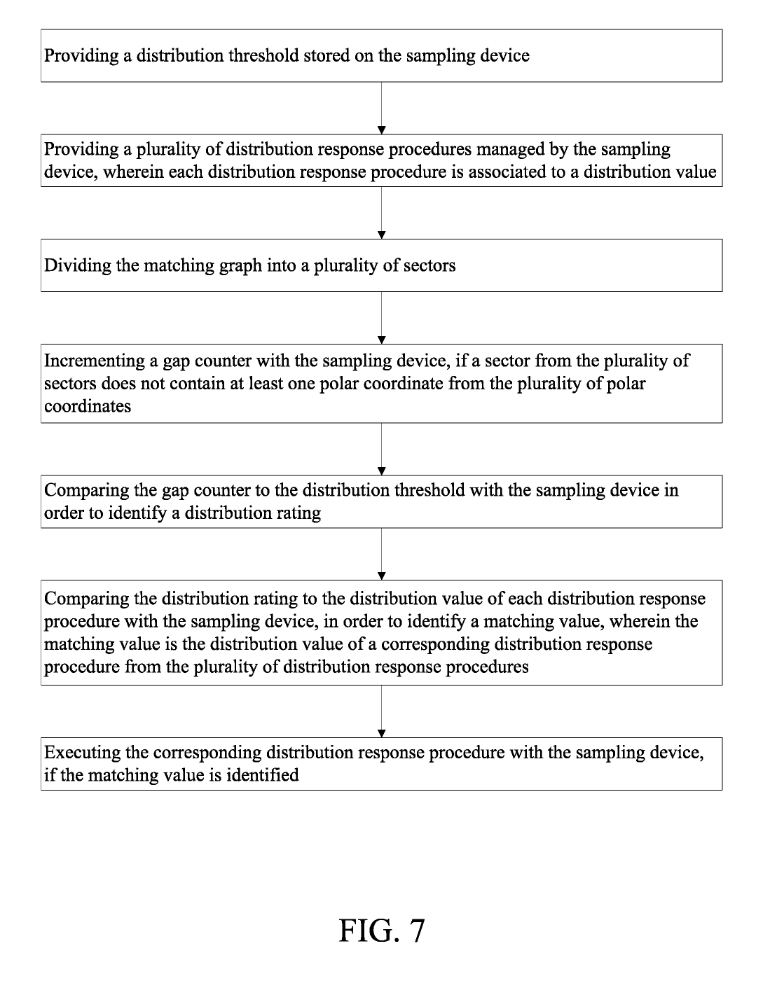

Referring to FIG. 5 and FIG. 7, a second sub-process of the validity checking process is used to assess the angular distribution of the signal data. To facilitate this sub-process, the system for executing the method of the present invention provides a distribution threshold stored on the sampling device. The distribution threshold is a predefined value that denotes a cutoff point for signal data that is considered valid. The system for executing the method of the present invention further provides a plurality of distribution response procedures managed by the sampling device. The plurality of distribution response procedures comprises a set of routines that denote the proper steps to take after the angular distribution of the signal data is analyzed. Additionally, each distribution response procedure is associated to a distribution value. The distribution value denotes a score that will be assigned to the signal data after the angular distribution is analyzed. The sub-process begins by dividing the matching graph into a plurality of sectors so that the plurality of polar coordinates can be grouped as desired. Preferably the matching graph is divided into 360 sectors where each sector is associated with a single degree of a polar coordinate plane. The sub-process continues by incrementing a gap counter with the sampling device, if a sector from the plurality of sectors does not contain at least one polar coordinate from the plurality of polar coordinates. Accordingly, the sub-process is able to determine the distribution of polar coordinates and thus the uniformity of the signal data. Specifically, the sub process continues by comparing the gap counter to the distribution threshold with the sampling device in order to identify a distribution rating. The distribution rating identifies the signal data as valid or invalid and assigns a value to the denote the angular distribution of the signal data. The sub-process continues by comparing the distribution rating to the distribution value of each distribution response procedure with the sampling device, in order to identify a matching value. In this sub-process, the matching value is the distribution value of a corresponding distribution response procedure from the plurality of distribution response procedures. Accordingly, the sub-process is able to identify the appropriate distribution response procedure to execute. The sub-process concludes by executing the corresponding distribution response procedure with the sampling device, if the matching value is identified.

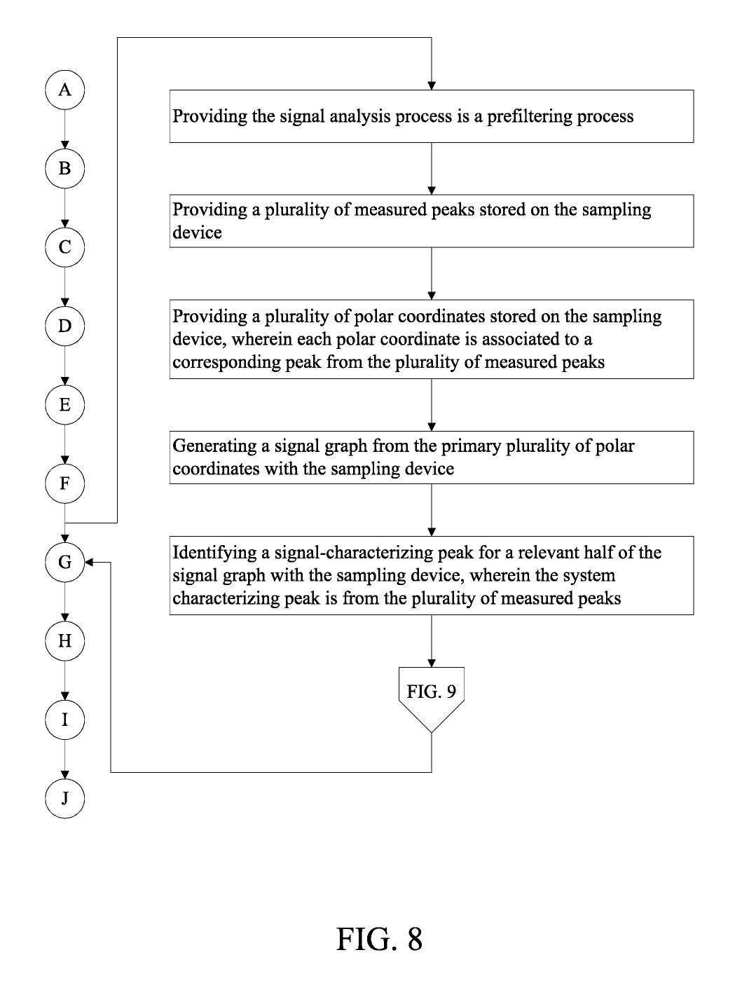

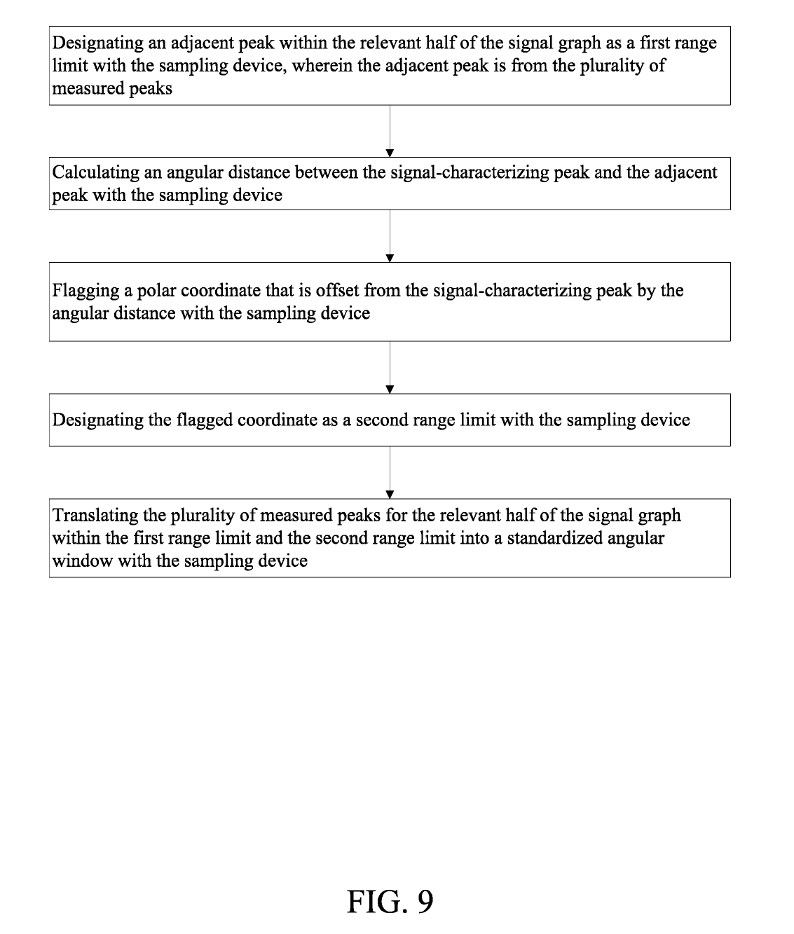

Referring to FIG. 8 and FIG. 9, the method of the present invention is designed to generate a normalized coordinate plane representation of the signal data, which facilitates further signal analysis. To that end, the plurality of signal analysis processes includes a prefiltering process that is executed to calculate range limits for the signal data. The prefiltering process is designed to compare two or more out of phase signals to determine the ranges within which the operational characteristics of the measuring device fall. To facilitate this, the system for executing the method of the present invention includes a primary signal dataset and a secondary signal dataset within the plurality of signal datasets. The primary signal dataset comprises signal data that is generated by a first sensor of the measuring device. Similarly, the secondary signal dataset comprises signal data that is generated by a second sensor of the measuring device. By extrapolating a relationship between the primary signal dataset and the secondary signal dataset the sampling device is able to identify relevant information about the operational characteristics of the measuring device. For example, if the measuring device is a linear encoder the read head may contain two sensors that determine the direction of motion along a linear track. Specifically, the signal dataset includes a plurality of polar coordinates where each polar coordinate is associated to a corresponding peak from the plurality of measured peaks. The prefiltering process begins generating a primary signal graph from the plurality of polar coordinates with the sampling device. As a result, the graphical representations of the signal dataset can be analyzed to identify pertinent information about the operational characteristics of the measuring device.

Referring to FIG. 8 and FIG. 9, the signal graph and the secondary signal graph is designed to function as a graphical representation of the signal dataset. These representations are analyzed to generate a normalized coordinate plane representation of the plurality of measured peaks that characterize the signal dataset. To that end, the prefiltering process continues by identifying a signal-characterizing peak for a relevant half of the signal graph with the sampling device. The signal-characterizing peak is one of the plurality of measured peaks that can be used to characterize the operation of the measuring device while the measuring device output signals that fall within a desired range. Specifically, the relevant half of the signal graph defines a portion of the signal dataset that will be characterized during the pre-filtering process. Additionally, the prefiltering process is designed to be repeated on multiple sections of the signal graph until the entire signal dataset is characterized. The prefiltering process continues by designating an adjacent peak within the relevant half of the signal graph as a first range limit with the sampling device. The adjacent peak is the next measured peak that is located within the same half of the signal graph as the signal-characterizing peak. Accordingly, the prefiltering process is able to identify the maximum range of values for the signal data that exist to one side of the signal-characterizing peak. The prefiltering process continues defining the range of possible values by calculating an angular distance between the signal-characterizing peak and the adjacent peak with the sampling device. Further, the prefiltering process continues by flagging a polar coordinate that is offset from the signal-characterizing peak by the angular distance with the sampling device. Relatedly, the range characterization continues by designating the flagged coordinate as a second range limit with the sampling device. Accordingly, the prefiltering process identifies the maximum range of values for the signal data that exist to the side of the signal-characterizing peak opposite to the adjacent peak.

Referring to FIG. 8 and FIG. 9, the first range limit is a value that represents a first boundary of the normalized coordinate plane representation. The second range limit is a value that represents a second boundary of the normalized coordinate plane representation. Thus defined, the normalized coordinate plane representation is able to capture and characterize all relevant signal data within a corresponding subset of the signal dataset. After the boundaries for the normalized coordinate plane have been defined, the prefiltering process continues by translating the plurality of measured peaks for the relevant half of the signal graph within the first range limit and the second range limit into a standardized angular window with the sampling device. Accordingly, the plurality of measured peaks for the relevant half of the signal graph is converted into a coordinate representation, which facilitates further signal data analysis. Preferably the plurality of measured peaks for the relevant half of the signal graph is translated to a range between zero and 180 degrees.

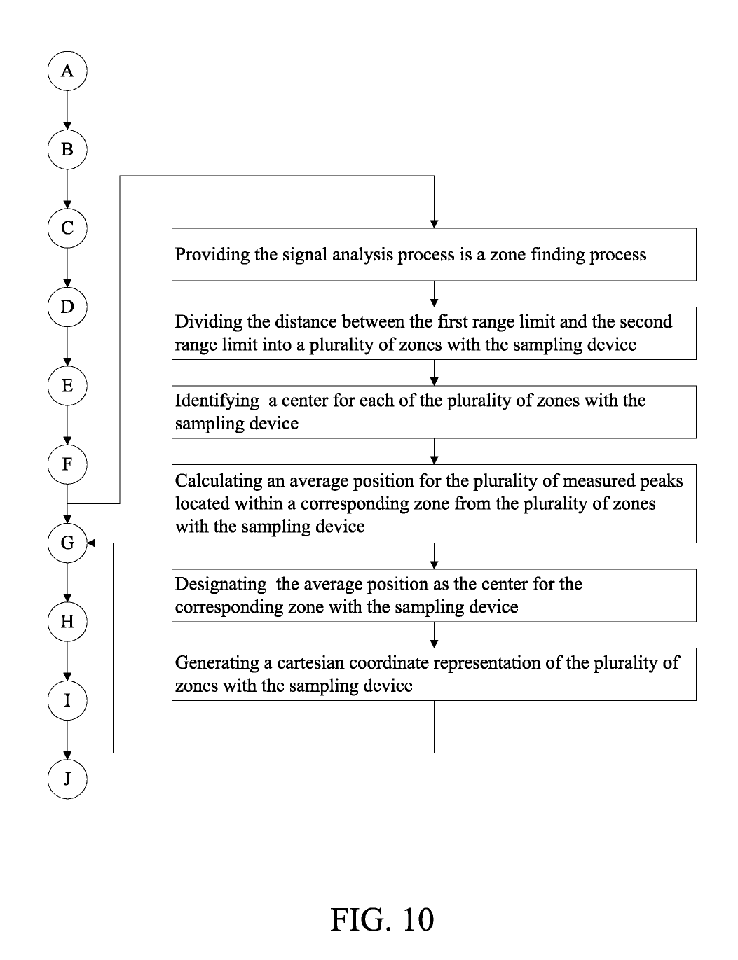

Referring to FIG. 10, the method of the present invention is designed to divide the normalized coordinate plane representation of the signal data into a plurality of distinct zones. To that end, the plurality of signal analysis processes includes a zone finding process that is executed to calculate range limits for a plurality of zones which can be used to further characterize the signal data. The zone finding process is designed to identify the average values for the signal data found within the plurality of zones. The zone finding process begins by dividing the distance between the first range limit and the second range limit into a plurality of zones with the sampling device. Accordingly, various portions of the signal data can be described by analyzing a relevant zone. The zone finding process continues by identifying a center for each of the plurality of zones with the sampling device. The center is a coordinate that corresponds to the angular or spatial center of each zone. The zone finding process continues by calculating an average position for the plurality of measured peaks located within a corresponding zone from the plurality of zones with the sampling device. As a result, the zone finding process is able to determine the average value of all the signal data contained within each zone. The zone-finding process continues by designating the average position as the center for the corresponding zone with the sampling device. Thus designated, the corresponding zone is repositioned to be centered around the center. The zone finding process continues by generating a cartesian coordinate representation of the plurality of zones with the sampling device. Accordingly, each zone can be used to characterize the average position of the signal data at various points within the zone

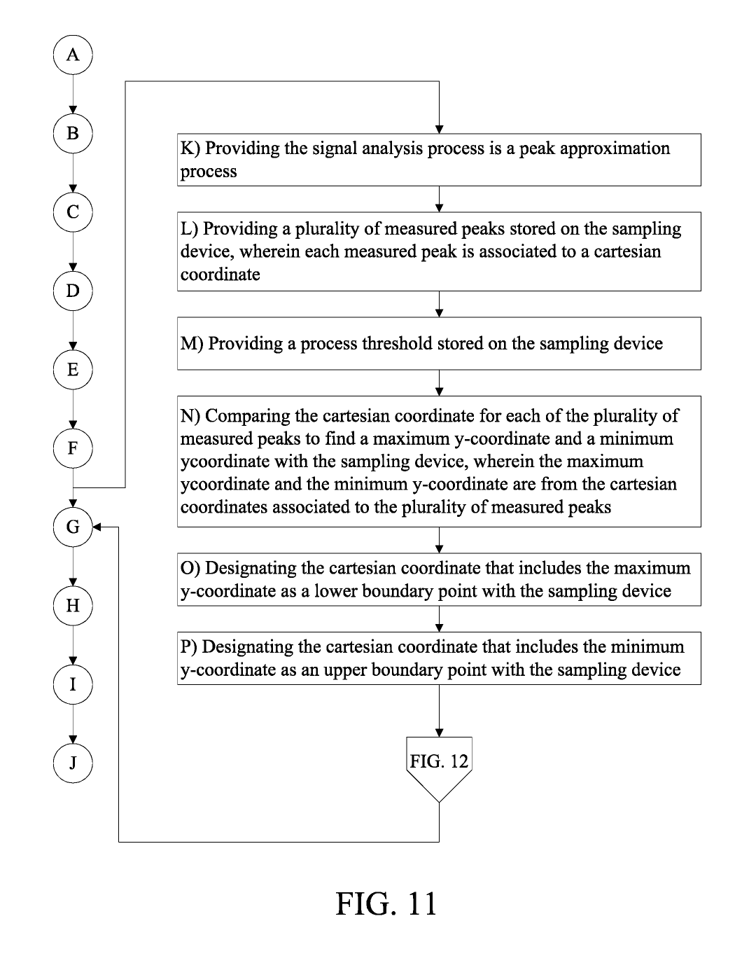

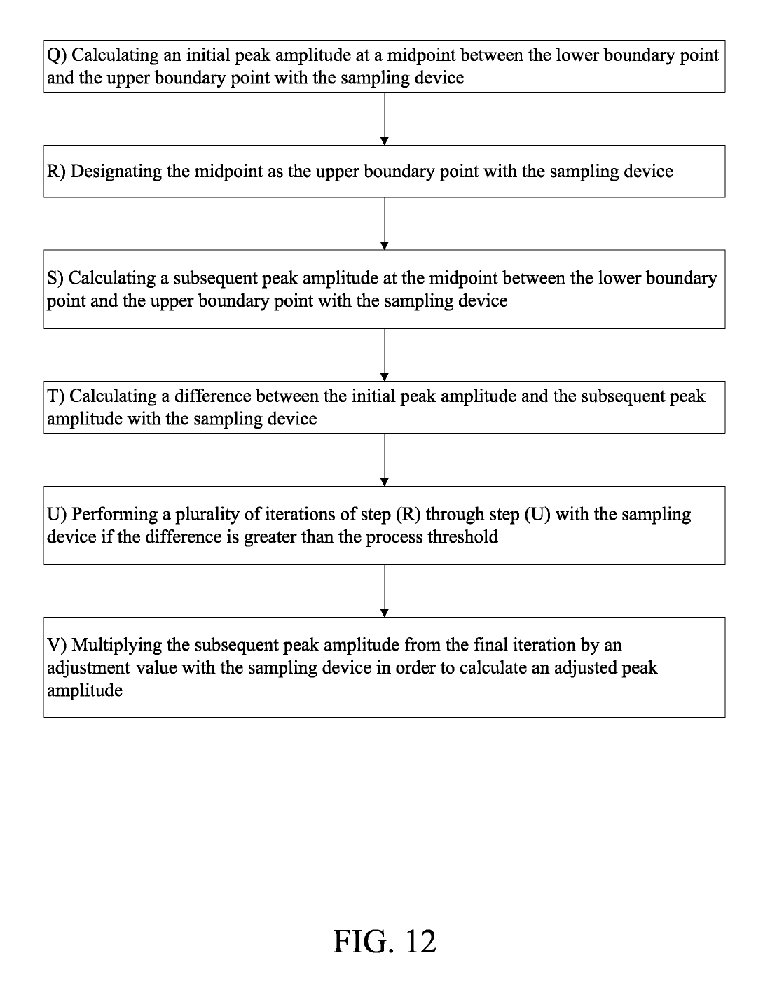

Referring to FIG. 11 and FIG. 12, the method of the present invention is designed to plot the averaged values of the plurality of measured peaks found in the plurality of sectors. To that end, the plurality of signal analysis processes includes a peak approximation process. The peak approximation process that employs a reiterative calculation methodology to generate a plot that characterizes the average values of the plurality of measured peaks that can be found in each of the plurality of sectors. The system for executing the method of the present invention provides a process threshold (Step M). The process threshold is a value used to characterize a lower bound, below which incremental changes between elements of the signal datasets is not considered to be useful. The peak approximation process begins by comparing the cartesian coordinate for each of the plurality of measured peaks to find a maximum y-coordinate and a minimum y-coordinate with the sampling device (Step N). The maximum y-coordinate and the minimum y-coordinate are from the cartesian coordinates associated to the plurality of measured peaks. The peak approximation process continues by designating the cartesian coordinate that includes the maximum y-coordinate as a lower boundary point with the sampling device (Step O). Additionally, the sub-process continues by designating the cartesian coordinate that includes the minimum y-coordinate as an upper boundary point with the sampling device. The peak approximation process continues by designating the cartesian coordinate that includes the minimum y-coordinate as an upper boundary point with the sampling device (Step P). As a result, the maximum y-coordinate and the minimum y-coordinate denote the boundaries between which the average values of the plurality of measured peaks will be plotted. Thus bounded, the peak approximation process continues by calculating an initial peak amplitude at a midpoint between the lower boundary point and the upper boundary point with the sampling device (Step Q). The initial peak amplitude is an averaged value that is calculated from the maximum y-coordinate and the minimum y-coordinate.

Referring to FIG. 11 and FIG. 12, the peak approximation process is designed to perform a plurality of incremental iterations, each of which relocates the upper boundary point in order to identify the averaged peak that corresponds to the midpoint between the lower boundary point and the upper boundary point. To that end, the peak approximation process continues by designating the midpoint as the upper boundary point with the sampling device (Step R). The peak approximation process continues by calculating a subsequent peak amplitude at the midpoint between the lower boundary point and the upper boundary point with the sampling device (Step S). Accordingly, the subsequent peak amplitude characterizes the average value for the plurality of measured peaks that are positioned between the newly updated upper boundary point and the lower boundary point. The peak approximation process continues by calculating a difference between the initial peak amplitude and the subsequent peak amplitude with the sampling device (Step T). The peak approximation process continues by performing a plurality of iterations of Step Q through Step T with the sampling device if the difference is greater than the process threshold (Step U). Accordingly, the peak approximation process enters a loop that continues to calculate averaged peak amplitudes until the difference between the averaged peak amplitudes falls below the processing threshold. The peak approximation process continues by multiplying the subsequent peak amplitude from each iteration by an adjustment value with the sampling device in order to calculate an adjusted average amplitude (Step V). The adjusted average amplitude compensates for reductions of the averaged amplitude that are caused by the sector averaging and various other signal analysis processes.

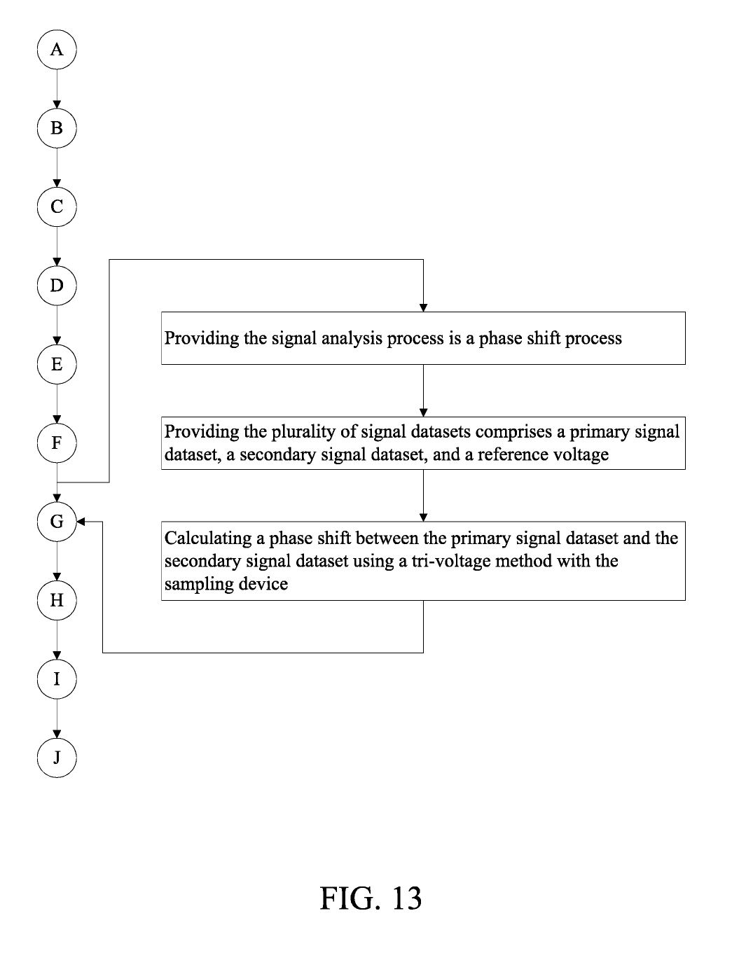

Referring to FIG. 13, the method of the present invention is designed to calculate the relationship between each of the plurality of signal datasets with respect to time. To that end, the plurality of signal analysis processes includes a phase shift process. The phase shift process is designed to calculate the phase shift between the plurality of signal datasets. To facilitate this, the system for executing the method of the present invention includes a primary signal dataset, a secondary signal dataset, and a reference voltage within the plurality of signal datasets. The phase shift process concludes by calculating a phase shift between the primary signal dataset and the secondary signal dataset using a tri-voltage method with the sampling device. Accordingly, the phase shift identifies the time-dependent relationship between the primary signal dataset and the second signal dataset. In addition to phase shift the operational characteristics that are calculated by the method of the present invention are values that include, but are not limited to, an amplitude of the first dataset, an amplitude of the second dataset, a bias offset of the first dataset, a bias offset of the second dataset, a phase relationship between the first dataset and the second dataset, and a symmetry relationship between the first dataset and the second dataset.

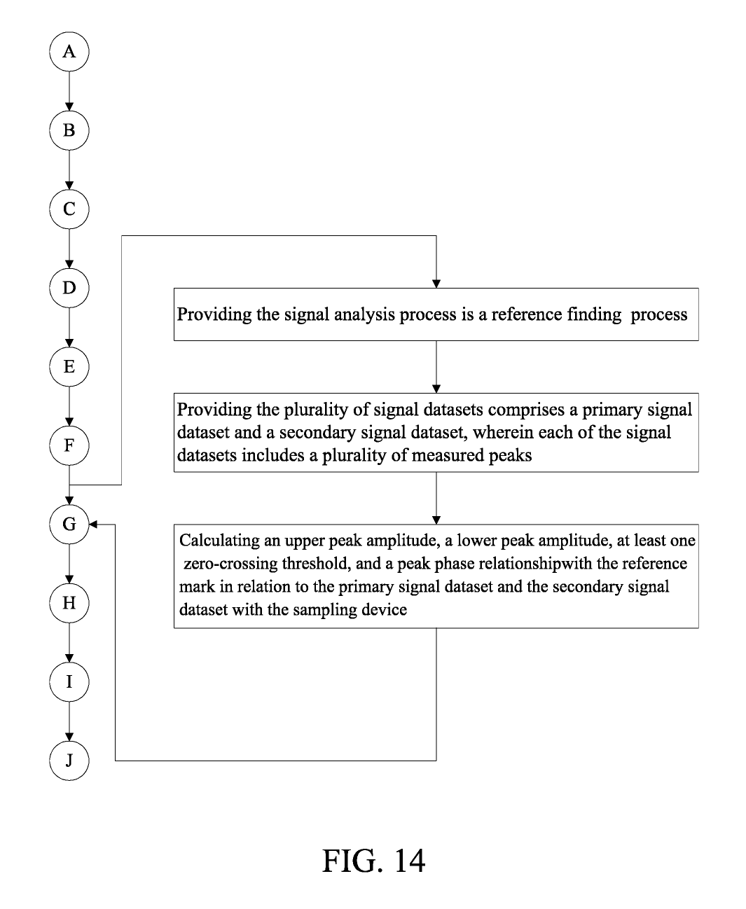

Referring to FIG. 14, the method of the present invention is designed to identify the presence of a reference mark within the plurality of signal datasets. To that end, the plurality of signal analysis processes includes a reference finding process. The reference finding process is designed to identify key characteristics of the reference mark. Specifically, the reference finding process is used to calculate an upper switching threshold, a lower switching threshold, at least one zero-crossing threshold, and a peak phase threshold as they relate to the primary signal dataset and the secondary signal dataset with the sampling device. The upper switching threshold is a coordinate that represents the peak of the reference curve. The reference peak phase is calculated by determining the phase relationship of the primary signal dataset and the secondary signal dataset at the time that the reference peak amplitude occurs. The lower switching threshold is a coordinate that describes a point beyond which no useable signal data can be acquired. Specifically, the lower switching threshold is calculated by performing a series of calculations that begin by first scanning the reference plot from the reference peak to a distal end. The scan of the reference plot is satisfied when an incremental sum between a plurality of distal-end points is calculated to be less than the process threshold. The coordinate at which the scan is satisfied is used as an index marker to set a first boundary for the plurality of distal-end points which will be included in the calculations for the lower switching threshold. Specifically, the plurality of distal-end from the index marker to the nearest end of the reference plot will be averaged to calculate the lower switching threshold value. The zero crossover values are calculated by determining the phase relationship of the primary signal dataset and the secondary signal dataset at the time that the reference plot transitions electrical zero.

Although the invention has been explained in relation to its preferred embodiment, it is to be understood that many other possible modifications and variations can be made without departing from the spirit and scope of the invention as hereinafter claimed.

What is claimed is:

1. A method of analyzing signal quality in order to determine the operational characteristics of a measuring device, the method comprising the steps of:
(A) providing at least one sampling device, wherein the sampling device is communicably coupled to at least one remote server;
(B) providing at least one user account managed by the remote server, wherein the user account is associated to a personal computing (PC) device;
(C) providing a plurality of tolerancing values stored on the sampling device;
(D) providing a plurality of signal analysis processes managed by the sampling device;
(E) sending a connection status request from the sampling device to the remote server;
(F) receiving a plurality of signal datasets with the sampling device;
(G) inputting the signal datasets into at least one signal analysis process with the sampling device in order to generate signal characteristic data;
(H) comparing the signal characteristic data to the plurality of tolerancing values with the sampling device in order to generate a tolerancing report;
(I) sending the tolerancing report to the PC device;
(J) prompting to select a desired process with the PC device, wherein the desired process is from the plurality of signal analysis processes;

2. The method of analyzing signal quality in order to determine the operational characteristics of a measuring device, the method as claimed in claim 1 comprising the steps of:
providing the signal analysis process is a peak measuring process;
scanning the signal datasets for a plurality of measured peaks with the sampling device;

3. The method of analyzing signal quality in order to determine the operational characteristics of a measuring device, the method as claimed in claim 1 comprising the steps of:
providing the signal analysis process is a validity checking process;
providing a plurality of measured peaks stored on the sampling device;
providing a plurality of cartesian coordinate pairs stored on the sampling device, wherein each cartesian coordinate pair is associated to a corresponding peak from the plurality of measured peaks;
providing a reference graph stored on the sampling device;
generating a signal graph from the plurality of cartesian coordinate pairs with the sampling device;
comparing the signal graph to the reference graph with the sampling device in order to identify a matching graph trigger;
converting the plurality of cartesian coordinate pairs to a plurality of polar coordinates with the sampling device, if the matching graph trigger is identified;

4. The method of analyzing signal quality in order to determine the operational characteristics of a measuring device, the method as claimed in claim 3 comprising the steps of:
providing a linearity threshold stored on the sampling device;
providing a plurality of linearity response procedures managed by the sampling device, wherein each linearity response procedure is associated to a linearity value;
calculating an angular change between an arbitrary coordinate and an adjacent coordinate with the sampling device, wherein the arbitrary coordinate and the adjacent coordinate are from the plurality of polar coordinates;
calculating a linearity ratio of a maximum angular change and a minimum angular change between the plurality of polar coordinates;
comparing the linearity ratio to the linearity threshold with the sampling device in order to identify a linearity rating;
comparing the linearity rating to the linearity value of each linearity response procedure with the sampling device, in order to identify a matching value, wherein the matching value is the linearity value of a corresponding linearity response procedure from the plurality of linearity response procedures;
executing the corresponding linearity response procedure with the sampling device, if the matching value is identified;

5. The method of analyzing signal quality in order to determine the operational characteristics of a measuring device, the method as claimed in claim 3 comprising the steps of:
providing a distribution threshold stored on the sampling device;
providing a plurality of distribution response procedures managed by the sampling device, wherein each distribution response procedure is associated to a distribution value;
dividing the matching graph into a plurality of sectors;
incrementing a gap counter with the sampling device, if a sector from the plurality of sectors does not contain at least one polar coordinate from the plurality of polar coordinates;
comparing the gap counter to the distribution threshold with the sampling device in order to identify a distribution rating;
comparing the distribution rating to the distribution value of each distribution response procedure with the sampling device, in order to identify a matching value, wherein the matching value is the distribution value of a corresponding distribution response procedure from the plurality of distribution response procedures;
executing the corresponding distribution response procedure with the sampling device, if the matching value is identified;

6. The method of analyzing signal quality in order to determine the operational characteristics of a measuring device, the method as claimed in claim 1 comprising the steps of:
providing the signal analysis process is a prefiltering process;
providing a plurality of measured peaks stored on the sampling device;
providing a plurality of polar coordinates stored on the sampling device, wherein each polar coordinate is associated to a corresponding peak from the plurality of measured peaks;
generating a signal graph from the primary plurality of polar coordinates with the sampling device;
identifying a signal-characterizing peak for a relevant half of the signal graph with the sampling device, wherein the system characterizing peak is from the plurality of measured peaks;
designating an adjacent peak within the relevant half of the signal graph as a first range limit with the sampling device, wherein the adjacent peak is from the plurality of measured peaks;
calculating an angular distance between the signal-characterizing peak and the adjacent peak with the sampling device;
flagging a polar coordinate that is offset from the signal-characterizing peak by the angular distance with the sampling device;
designating the flagged coordinate as a second range limit with the sampling device;
translating the plurality of measured peaks for the relevant half of the signal graph within the first range limit and the second range limit into a standardized angular window with the sampling device;

7. The method of analyzing signal quality in order to determine the operational characteristics of a measuring device, the method as claimed in claim 6 comprising the steps of:
providing the signal analysis process is a zone finding process;
dividing the distance between the first range limit and the second range limit into a plurality of zones with the sampling device;
identifying a center for each of the plurality of zones with the sampling device;
calculating an average position for the plurality of measured peaks located within a corresponding zone from the plurality of zones with the sampling device;
designating the average position as the center for the corresponding zone with the sampling device;
generating a cartesian coordinate representation of the plurality of zones with the sampling device;

8. The method of analyzing signal quality in order to determine the operational characteristics of a measuring device, the method as claimed in claim 1 comprising the steps of:
(K) providing the signal analysis process is a peak approximation process;
(L) providing a plurality of measured peaks stored on the sampling device, wherein each measured peak is associated to a cartesian coordinate;
(M) providing a process threshold stored on the sampling device;
(N) comparing the cartesian coordinate for each of the plurality of measured peaks to find a maximum y-coordinate and a minimum y-coordinate with the sampling device, wherein the maximum y-coordinate and the minimum y-coordinate are from the cartesian coordinates associated to the plurality of measured peaks;
(O) designating the cartesian coordinate that includes the maximum y-coordinate as a lower boundary point with the sampling device;
(P) designating the cartesian coordinate that includes the minimum y-coordinate as an upper boundary point with the sampling device;
(Q) calculating an initial peak amplitude at a midpoint between the lower boundary point and the upper boundary point with the sampling device;
(R) designating the midpoint as the upper boundary point with the sampling device;
(S) calculating a subsequent peak amplitude at the midpoint between the lower boundary point and the upper boundary point with the sampling device;
(T) calculating a difference between the initial peak amplitude and the subsequent peak amplitude with the sampling device;
(U) performing a plurality of iterations of step (R) through step (U) with the sampling device if the difference is greater than the process threshold;
(V) multiplying the subsequent peak amplitude from the final iteration by an adjustment value with the sampling device in order to calculate an adjusted average amplitude;

9. The method of analyzing signal quality in order to determine the operational characteristics of a measuring device, the method as claimed in claim 1 comprising the steps of:
providing the signal analysis process is a phase shift process;
providing the plurality of signal datasets comprises a primary signal dataset, a secondary signal dataset, and a reference voltage;
calculating a phase shift between the primary signal dataset and the secondary signal dataset using a tri-voltage method with the sampling device;

10. The method of analyzing signal quality in order to determine the operational characteristics of a measuring device, the method as claimed in claim 1 comprising the steps of:
providing the signal analysis process is a reference finding process;
providing the plurality of signal datasets comprises a primary signal dataset, a secondary signal dataset, and a reference signal dataset, wherein the primary signal dataset and the secondary signal dataset includes a plurality of measured peaks;
providing at least one reference peak associated to the reference mark;
extrapolating an upper peak amplitude, a lower peak amplitude, at least one zero-crossing threshold, and a peak phase relationship with the reference mark in relation to the primary signal dataset and the secondary signal dataset with the sampling device;
